(19) United States
(12) Patent Application Publication
(10) Pub. No.: US 2004/0233800 A1
(43) Pub. Date: Nov. 25, 2004

(54) Optical pickup device

(75) Inventor: Yuji Takaiwa, Yokohama-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/805,535

(22) Filed: Mar. 22, 2004

(30) Foreign Application Priority Data
Apr. 28, 2003 (JP) 2003-124120

(51) Int. Cl. G11B 7/00

(52) U.S. Cl. 369/44.14

(57) ABSTRACT

An optical pickup device moving objective caused to face disk medium, in tracking direction with respect to disk medium, optical pickup device includes holder holding objective, clamping member clamping holder in such a manner that holder can be moved freely in the tracking direction, support member supporting clamping member, base section to which the support member is fixed, magnetic member being fixed to base section via yoke section moveable in the tracking direction, electromagnet being held by holder and is provided in a space between magnetic member and yoke section and which moves objective in the tracking direction by electromagnetic forces produced between electromagnet and magnetic member according to the amount of electricity, and travel distance limiting member being fixed to magnetic member and limits the travel distance of holder in the tracking direction.

### CROSS-REFERENCE TO RELATED APPLICATIONS

This application is based upon and claims the benefit of priority from prior Japanese Patent Application No. 2003-124120, filed Apr. 28, 2003, the entire contents of which are incorporated herein by reference.

### BACKGROUND OF THE INVENTION

1. Field of the Invention

This invention relates to an optical pickup device used in an optical disk apparatus. More particularly, this invention relates to an improvement in the actuator moving mechanism of the head of the optical pickup device.

2. Description of the Related Art

An optical pickup device is applied as an optical signal read or write head for a disk medium in a CD (Compact Disk) player or a DVD (Digital Versatile Disk) unit. The optical pickup device comprises an objective provided so as to face the disk medium and a yoke section on which the objective is mounted. The objective is held by a holder. The holder is moved by the magnetic action of a permanent magnet and an electromagnet, which enables the objective to move with respect to the recording medium.

When the objective is moved, the magnetic imbalance between the holder and magnet has to be corrected. In an exiting optical pickup device, the deterioration of the characteristics due to the magnetic imbalance caused when the position of the objective changes is suppressed by moving the yoke on which the objective is mounted. In this approach, however, an imbalance develops in the movement range of the objective. As a result, the following problems arise: the signal cannot be read or stress is applied to the wire holding the objective, resulting in a change in the characteristic. There is another problem: the standard for objective travel distance cannot be fulfilled. In addition, the nonlinearity of the relationship between the input voltage and the movement and a change in the tilt angle of the objective also become problems.

Related techniques have been disclosed in Jpn. Pat. Appln. KOKAI Publication No. 2003-6092 (hereinafter, referred to as reference 1), Jpn. Pat. Appln. KOKAI Publication No. 10-106013 (hereinafter, referred to as reference 2), and Jpn. Pat. Appln. KOKAI Publication No. 2001-229555 (hereinafter, referred to as reference 3). Reference 1 has disclosed an optical pickup which holds the objective and the aberration correcting mechanism in such a manner that they can move as one unit, thereby avoiding effectively the deterioration of the characteristic due to the misalignment of the objective with the aberration correcting mechanism. Reference 2 has disclosed an optical head lens holder indicator which enables not only a support beam for supporting the lens holding member in such a manner that the member can move freely in the focusing and tracking directions to be manufactured with high accuracy but also the focusing and tracking control performance to be improved. Reference 3 has disclosed not only a lens driving device in which a lens holder constituting a moving part and a connection wire connecting a plurality of driving coils electrically are formed integrally but also a method of manufacturing the lens driving device.

### BRIEF SUMMARY OF THE INVENTION

According to an aspect of the present invention, there is provided a optical pickup device which moves an objective caused to face a disk medium, in a tracking direction with respect to the disk medium, the optical pickup device comprises a holder which holds the objective; a clamping member which clamps the holder in such a manner that the holder can be moved freely in the tracking direction; a support member which supports the clamping member; a base section to which the support member is fixed; a magnetic member which is fixed to the base section via a yoke section moveable in the tracking direction; an electromagnet which is held by the holder and is provided in a space between the magnetic member and the yoke section and which moves the objective in the tracking direction by electromagnetic forces produced between the electromagnet and the magnetic member according to the amount of electricity; and a travel distance limiting member which is fixed to the magnetic member and limits the travel distance of the holder in the tracking direction.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a front view of an embodiment of an optical pickup device according to an embodiment of the present invention;

FIG. 2 is a sectional view of the optical pickup device taken along line II-II of FIG. 1;

FIG. 3 is a perspective view of the embodiment of the optical pickup device of FIG. 1; and

FIG. 4 is a front view of an existing optical pickup device for comparison.

### DETAILED DESCRIPTION OF THE INVENTION

Hereinafter, referring to the accompanying drawings, an embodiment of the present invention will be explained in detail.

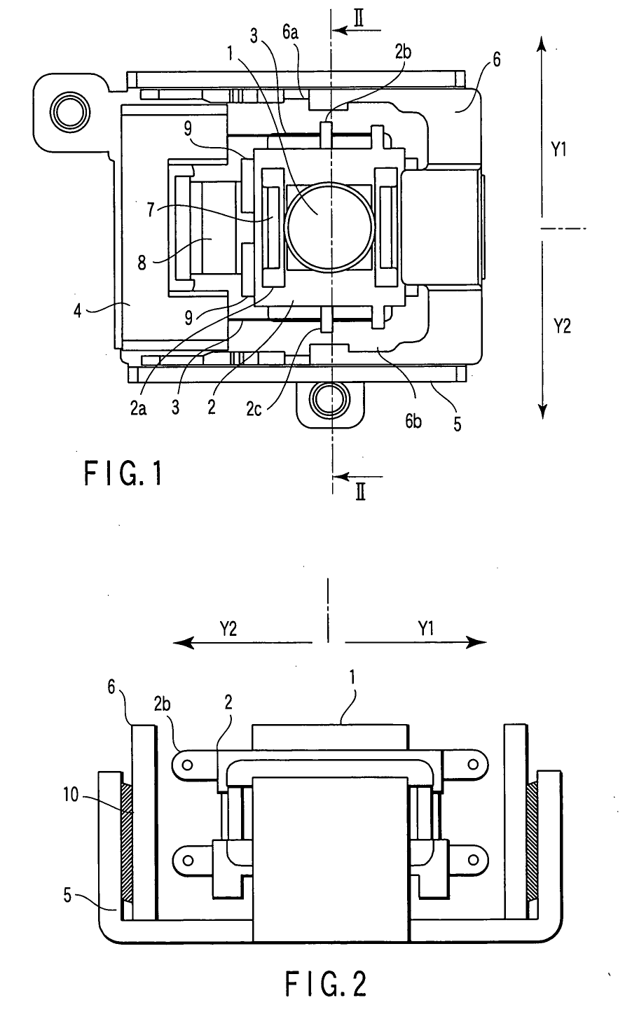

FIG. 1 is a front view of an embodiment of an optical pickup device according to the present invention. In FIG. 1, a limiting member 6 is fixed to a magnet 8 with adhesive. The limiting member 6 has projecting parts 6a, 6b. The projecting part 6a faces an inner wall part 2b of a holder 2 and is extended from the Y1 direction toward the inner wall part 2b. The projecting part 6b faces an inner wall part 2c of the holder 2 and is extended from the Y2 direction toward the inner wall part 2c.

FIG. 2 is a sectional view of the optical pickup device taken along line II-II of FIG. 1. The limiting member 6 is fixed to a base 5 with an adhesive 10. Before the limiting member 6 is bonded to the base 5, the limiting member 6 is moved in the Y1 direction or Y2 direction and is so positioned that the movement range of the holder 2 fits in a specific movement range. Furthermore, the limiting member 6 has its inclination adjusted and is then so positioned that the tilt angle of the objective 1 before movement is equal to the tilt angle after movement. After the position of the limiting member and the tilt have been adjusted, the limiting member 6 is bonded to the base 5.

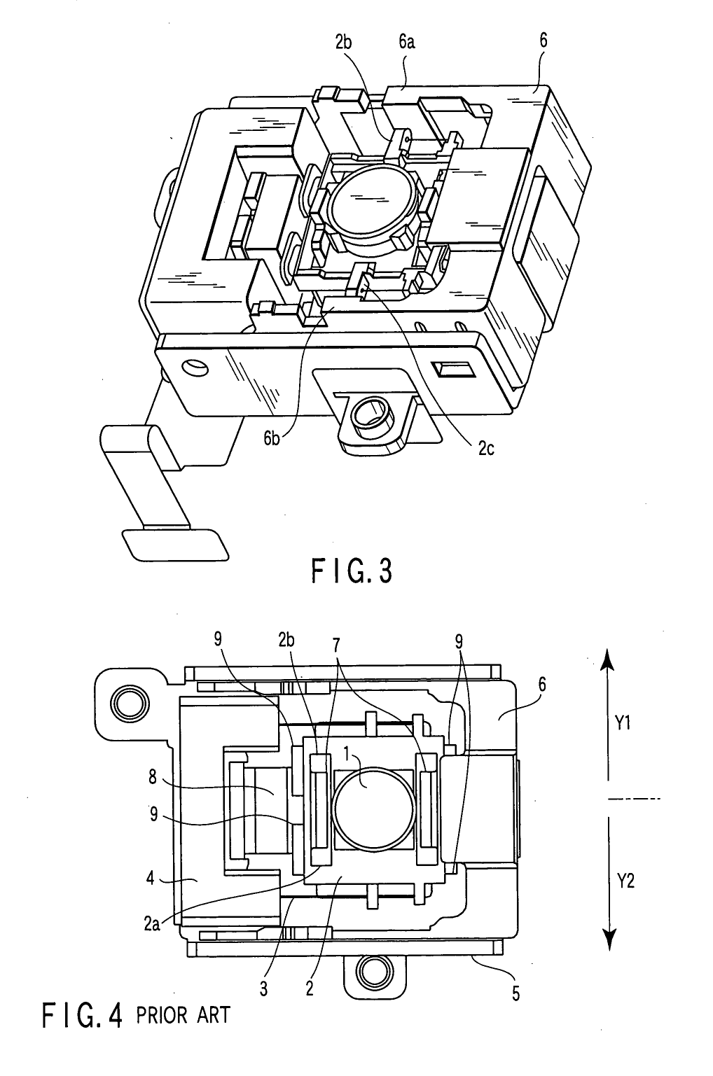

FIG. 3 is a perspective view of the embodiment of the optical pickup device of FIG. 1. As shown in FIG. 3, the projecting parts 6a, 6b of the limiting member 6 are provided so as to face the inner wall parts 2b, 2c of the holder 2, respectively.

With the above configuration, current is caused to flow in a coil 9, which causes the holder 2 to move, with the result that the objective 1 is moved in the Y1 direction and Y2 direction. The magnetic imbalance between the holder 2 and the magnet 8 is corrected by moving a yoke 7 in the Y1 or Y2 direction for adjustment.

Furthermore, the travel distance of the holder 2 is limited to a specific range as follows. After current is caused to flow in the coil 9, when the holder 2 has been moved in the Y1 direction and the movement has reached the limit in the Y1 direction, the holder inner wall part 2b comes into contact with the projecting part 6a. This limits the travel distance of the holder 2 in the Y1 direction to a specific range. Similarly, when the holder 2 has been moved in the Y2 direction and the movement has reached the limit in the Y2 direction, the holder inner wall part 2c comes into contact with the projecting part 6b. This limits the travel distance of the holder 2 in the Y2 direction to a specific range.

In the above configuration, the yoke 7 moves independently of the limiting member 6. This is because the limiting member 6 is fixed to the magnet 8. As a result, the adjustment of the magnetic imbalance and the limitation of the movement range of the holder 2 can be made independent of each other. This makes it possible to make the adjustment of the magnetic imbalance and the limitation of the movement range of the holder 2 compatible with each other without an adverse effect on each other.

Furthermore, as shown in FIG. 2, after the inclination of the limiting member 6 is so adjusted that the tilt angle of the objective 1 whose movement is limited is equal to its tilt angle before movement, the limiting member 6 is bonded to the base 5 with the adhesive 10. As a result, even when the travel distance of the holder 2 is limited, the inclination of the objective 1 can be kept constant, which enables the reading signal to be prevented from being cut off.

FIG. 4 is a front view of an existing optical pickup device for comparison. In FIG. 4, the objective 1 is held by the holder 2. The holder 2 is installed using a wire 3 in such a manner that the holder can be moved freely. Both ends of the wire 3 are fixed to a wire holder 4. The wire holder 4 is fixed to the base 5. The magnet 8 is fixed via the yoke 7 to the base 5 with adhesive. In the spacing between the magnet 8 and yoke 7, the coil 9 is so provided that it is held by the holder 2. When current is caused to flow in the coil 9, electromagnetic forces develop between the holder 2 and the magnet 8, which moves the holder 2. As a result, the objective 1 is moved in the Y1 direction and Y2 direction. The Y1 direction and Y2 direction correspond to the tracking direction of the disk medium.

The travel distance of the objective 1 in the Y1 direction is limited as a result of the holder inner wall part 2a and the yoke 7 coming into contact with each other. Similarly, the travel distance of the objective 1 in the Y2 direction is limited as a result of the holder inner wall part 2b and the yoke 7 coming into contact with each other.

When the objective 1 is in operation, it is necessary to correct the magnetic imbalance between the holder 2 and the magnet 8. With the above configuration, the yoke 7 is moved in the Y1 and Y2 directions, thereby correcting the magnetic imbalance. When the yoke 7 is moved in the Y1 direction, the travel distance of the holder 2 in the Y2 direction becomes smaller and its travel distance in the Y1 direction becomes larger. Conversely, when the yoke 7 is moved in the Y2 direction, the travel distance of the holder 2 in the Y1 direction becomes smaller and its travel distance in the Y2 direction becomes larger.

When the magnetic imbalance is corrected by moving the yoke 7 in this way, the movement range of the holder 2 varies according to the direction, with the result that the movement range becomes smaller or larger, depending on the direction. Since the inclination of the objective 1 becomes larger as the travel distance of the holder 2 becomes larger, this causes the problems of having an adverse effect on the reading of signals and permitting stress to be applied on the wire 3 and therefore the characteristic to change. When the travel distance of the holder 2 is small, the standard for travel distance cannot be satisfied. In addition to these problems, the following problems arise: the amount of correction of the magnetic imbalance is insufficient, the nonlinearity of the relationship between the input voltage and the movement occurs when no correction is made, and the tilt angle of the objective 1 changes.

In contrast, with the embodiment, the limiting member 6 is provided on the magnet 8. The projecting part 6a is formed on the limiting member 6. When the holder 2 is moved excessively in the Y1 direction, the holder inner wall part 2b and the projecting part 6a are brought into contact with each other, thereby limiting the amount of movement of the holder 2 in the Y1 direction. Similarly, the projecting part 6b is formed on the limiting member 6. When the holder 2 is moved excessively in the Y2 direction, the holder inner wall part 2c and the projecting part 6b are brought into contact with each other, thereby limiting the amount of movement of the holder 2 in the Y2 direction. In this way, the movement of the yoke 7 is prevented from having an effect on the limitation of the amount of movement of the holder 2. In addition, the adjustment of the magnetic imbalance and the adjustment to limit the travel distance of the objective 1 to a specific range are made independently.

In this way, the movement range of the objective 1 can be limited independently of the adjustment of the magnetic imbalance. Therefore, a good linearity of the relationship between the input voltage and the movement can be maintained in the movement range of the objective 1. In addition, a change in the tilt angle of the objective due to its movement is decreased, which prevents the reading of signals from being adversely affected and a physical stress from being. applied to the wire 3.

To summarize what has been explained above, in the embodiment, a member (or a travel distance limiting member) fixed to the magnetic member is additionally provided independently of the movement of the yoke. The travel distance limiting member is brought into contact with the holder, thereby adjusting the amount of movement of the holder. This makes it possible to make the adjustment of the magnetic imbalance and the adjustment of the travel distance of the holder independently. That is, even when an imbalance occurs in the travel distance of the holder 2 as a result of the movement of the yoke 7, the travel distance of the holder 2 can be set suitably.

Therefore, the adjustment of the magnetic imbalance prevents an imbalance from occurring in the travel distance of the holder in the Y1 and Y2 directions, which enables a change in the tilt angle of the objective to be decreased. Consequently, it is possible to provide an optical pickup device which can make the maintenance of a good linearity of the relationship between the input voltage and the movement and the proper setting of the travel distance compatible with each other.

The present invention is not limited to the above embodiment. For instance, when there is provided an actuator section which moves the base section to move the objective 1 in a direction to focus on the disk medium, the limiting member may be provided on the actuator section. In addition, when there is provided a dust-proofing member which covers the actuator section, the limiting member may be provided on the dust-proofing member.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical pickup device which moves an objective caused to face a disk medium, in a tracking direction with respect to the disk medium, the optical pickup device comprising:
a holder which holds the objective;
a clamping member which clamps the holder in such a manner that the holder can be moved freely in the tracking direction;
a support member which supports the clamping member;
a base section to which the support member is fixed;
a magnetic member which is fixed to the base section via a yoke section moveable in the tracking direction;
an electromagnet which is held by the holder and is provided in a space between the magnetic member and the yoke section and which moves the objective in the tracking direction by electromagnetic forces produced between the electromagnet and the magnetic member according to the amount of electricity; and
a travel distance limiting member which is fixed to the magnetic member and limits the travel distance of the holder in the tracking direction.

2. The optical pickup device according to claim 1, wherein the travel distance limiting member has projecting parts which come into contact with the holder.

3. The optical pickup device according to claim 1, wherein the travel distance limiting member is fixed to the magnetic member, after the limited amount of movement of the holder in the tracking direction is adjusted in the opposite direction to the tracking direction.

4. The optical pickup device according to claim 1, wherein the travel distance limiting member is fixed to the magnetic member, after the inclination of the holder in the direction of movement is adjusted.

5. The optical pickup device according to claim 1, further comprising an actuator section on which the base section is provided and which moves the objective in a focusing direction with respect to the disk medium, wherein
the travel distance limiting member is provided on the actuator section.

6. The optical pickup device according to claim 1, further comprising:
an actuator section on which the base section is provided and which moves the base section freely; and
a dust-proofing member which covers the actuator section, wherein
the travel distance limiting member is provided on the dust-proofing member.
